(19) United States
(12) Patent Application Publication
(10) Pub. No.: US 2011/0192852 A1
(43) Pub. Date: Aug. 11, 2011

(54) INSULATED FOOD CONTAINER

(75) Inventor: John Kennedy Chebli, Raleigh, NC (US)

(73) Assignee: Global Trading Associates

(21) Appl. No.: 12/701,994

(22) Filed: Feb. 8, 2010

(51) Int. Cl. A47J 41/00

(52) U.S. Cl. 220/592.21

(57) ABSTRACT

The present invention relates to an insulated take home food container. In particular, the present invention relates to a laminate of aluminum foil, either flat or in a manner to create air pockets, utilized to increase the holding time a food stays warm in the container. The container can have flat surface or dividing walls depending on the use of the box.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a container for keeping food warm, moist and fresh. In particular, the present invention relates to an insulated food container designed to keep hot food warmer, more moist, and fresher for longer periods of time.

2. Description of Related Art

Food delivery or take out of food, e.g. fast food, has long been a mainstay within the United States. While most fast food or regular restaurants serve food within their restaurants, a great majority of them offer food to go or delivery of food. Since most fast food is a hot product, best served fresh out of the oven, keeping food warm and moist during delivery or on the drive home has been a difficult problem for decades.

For home delivery, ovens and reusable containers have frequently been utilized. However, for take home use, the container must be of a disposable kind and expensive products are clearly unsuitable. Typically, food is placed in a cardboard, Styrofoam or other inexpensive material container. While the containers are very inexpensive and do a reasonable job handling moisture collection from hot food, it is not very good at retaining heat and moisture for a very long period of time. The cardboard or Styrofoam box does a good job in absorbing the moisture, however, it tends to dry out the food and makes it harder.

Several attempts to make a container that insulates better have been made, but mostly expensive solutions have been developed. Since the container must be included in the price of the food, anything that is difficult to make and/or uses expensive materials is unsuitable for a disposable container. Examples of unsuitable boxes include laminated polymers, dual layers of cardboard with an insulating material in-between such as a polymer or the like. These triple laminates, while an improvement in the heat retention, are too expensive to manufacture when compared to the single layer polymer cardboard container which can be cut out of a flat sheet or stamped to a shape.

It is a need within the industry to have a container which holds heat longer than 10 minutes or so, and keeps the food moist and fresh, yet is inexpensive to manufacture and uses inexpensive materials. Since many companies that deliver food offer 30 minute hot delivery, attempting to keep a food warm for that period without a separate heat source would be desirable, but to date has not been achieved.

### BRIEF SUMMARY OF THE INVENTION

It has been discovered that a relatively inexpensive and effective hot food container can be made by gluing or otherwise attaching a layer of aluminum foil on the inside of the container, even more insulation can be obtained by gluing the aluminum foil to the container in a manner such that air pockets are created between the aluminum foil and the container inner wall surface. The container will retain heat with or without the air pocket, but it will retain more heat with the air pocket embodiment.

Accordingly, in one embodiment, there is a food container having at least a portion of the interior surface of the container affixed with a layer of aluminum foil.

### BRIEF DESCRIPTION OF THE DRAWINGS

FIG. 1 is a top view of an open container of the present invention.

FIG. 2 is a top view of an open pizza box of the invention with air pockets.

FIGS. 3a and 3b are cross sections of a food container of the invention.

FIG. 4 is a sandwich container of the present invention.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein a “food container” refers to cardboard, plastic, or other stiff material, that has been cut or molded in such a way that when properly assembled creates a three dimensional container or box for placing and transporting a cooked, hot food such as pizza, hamburger, fried food, doggie box food, or the like. Typically, when cardboard is utilized, it is about a quarter to a third of an inch but various thicknesses can be used within the scope of the present invention. The cardboard or other material can also be perforated to aid in folding and can have printing, such as advertising or information, about the contents that will be in the container, i.e. hamburger. The container is usually held in its three dimensional configuration by tabs that are part of the container or just the general pressure of the material the container is made from against itself or by any other means known for creating cardboard or polymeric containers. In one embodiment the food container comprises one or more dividers for segmenting different foods in one container.

As used herein “heat reflective material” refers to any standard or specialty material that is food grade and is capable of reflecting heat and retaining moisture. In addition, the material should be relatively thin in order to accommodate the shape of the box and relatively cost effective. In one embodiment, the material is a metal foil such as aluminum foil. Aluminum foil is used in the cooking and baking industry. In other words, food grade aluminum foil would be utilized since in most cases it will come in contact with a food placed in the container. The reflective material can be smooth, textured, or the like, but in keeping with the spirit of the invention, inexpensive is better than expensive. The reflective material, such as aluminum foil, is affixed to the surface of the container by affixing it to the container's interior or exterior surface. Only a portion may be covered or parts may be covered on either the inside or outside of the container. One embodiment is entirely on the inside of the container. Affixation can be accomplished by gluing, or any other convenient method for attaching heat reflective material to the material of the container that is food safe in nature when used under these circumstances. Gluing can be done after the container is cut as well. One final cut can be made when the container is glued. This will place less holes in the container. When gluing aluminum foil to the surface of the container, in most cases, it will be easier to accomplish by doing such before the material is cut or molded into the final shape for use. Other heat reflective materials may be applied in different manners depending on the particular material and how the container will be assembled or made the particular material comprising the container. Glue can be applied entirely over the interior or exterior surface of the container material, in a pattern, or the like, since the aluminum foil or other material will stick as long as enough surface is contacted with the glue. In one embodiment, the glue pattern is such that a plurality of air pockets are created between the heat reflective material and the surface of the container. That is, by gluing in a manner that individual areas are completely sealed against the surface of the container, air is trapped in those areas between the aluminum foil and the surface of the container. In these embodiments, a pattern of glue can be applied, such as diamond, rectangular, or the like, for example, as shown in the Figures. The foil and/or the pockets do not necessarily have to be applied to the entire inner or outer surface of the container. While it might be simpler to coat the entire side of the container while making the container, applying only on the inner top or outer top, for example, could utilize less glue. One could also not apply the foil to the sides of the container, however, complete application of the foil to the inside surface of the container is certainly one embodiment of the present invention. Since aluminum foil is relatively cheaper than most container materials, the present utilization of aluminum foil adds little cost but insulates the container sufficiently and the container can be assembled in the normal manner. The present invention increases the holding time a food will stay warm and moist in the container of the present invention. In order to deal with any extra accumulated moisture inside the container, the heat reflective material could be perforated, have holes, or the like, or a layer of moisture absorbing material/paper can be placed in the container (over the food placed in the container) for the purpose of moisture wicking. Once the container has been laminated or formed, the aluminum foil is thin enough that it does not interfere with the construction of the container in the normal manner. In other embodiments, a layer of plastic material (such as plastic wrap or a polyethylene material) could be placed in the container either between the food and heat reflective material or otherwise to prevent the food from coming in contact with the container surface. The layer could be a film or sheet or other thickness as desired.

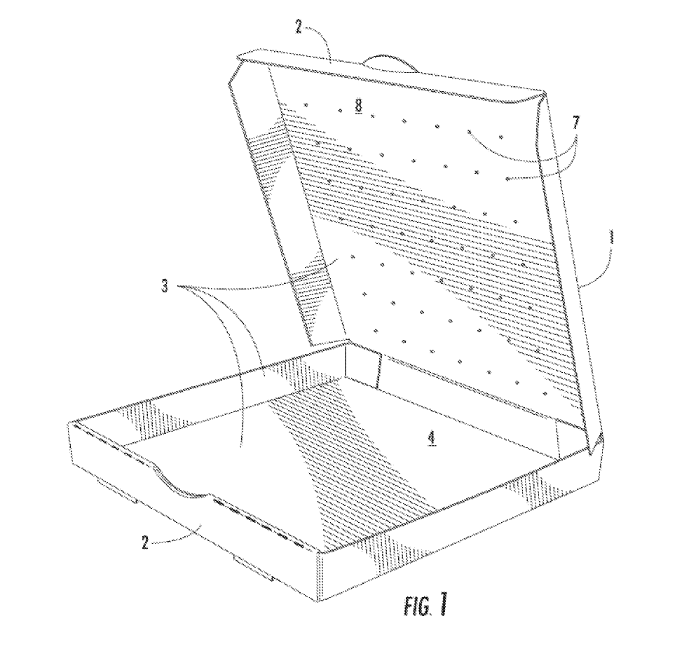

Now referring to the drawings, FIG. 1 is a perspective view of an open cardboard container, e.g. for pizza or the like with the invention lining of the present invention. Container 1 comprises outer surface 2 and inner surface 3. Outer surface 2 is the cardboard outer surface layer of the present invention container 1. Inner surface 3 is heat reflective aluminum foil (or other heat reflective material) 4 lined inner surface. In this embodiment the aluminum is attached to the inner surface of the container in an even manner (e.g. evenly applied glue or the like). In this embodiment the inner surface of lid 8 is perforated 7 in order to aid with moisture wicking. It is clear that this figure also indicates that the container could have the foil on the outer surface 2 of the container. In one embodiment, the container could be turned inside out and the container depicted in this figure used to have the aluminum foil on the outer surface 2.

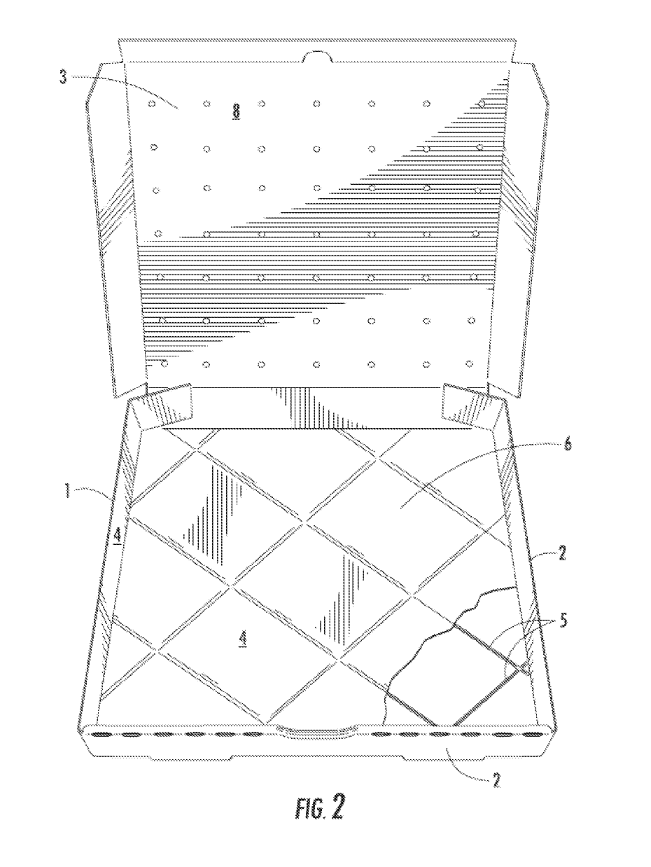

In FIG. 2, there is a front perspective of an open container 1 of the present invention. In this embodiment, the glue is applied between aluminum foil 4 and the cardboard box by glue lines 5. These glue lines create pockets 6 which trap air and provide better heat insulation. Note in this embodiment only a portion of the container is lined with the air pockets while the remaining interior is lined with smooth aluminum foil. One could easily vary the percentage of pockets and non-pocket areas as seen fit with the performance of the container. In one embodiment, all the aluminum foil is attached in this pocket manner.

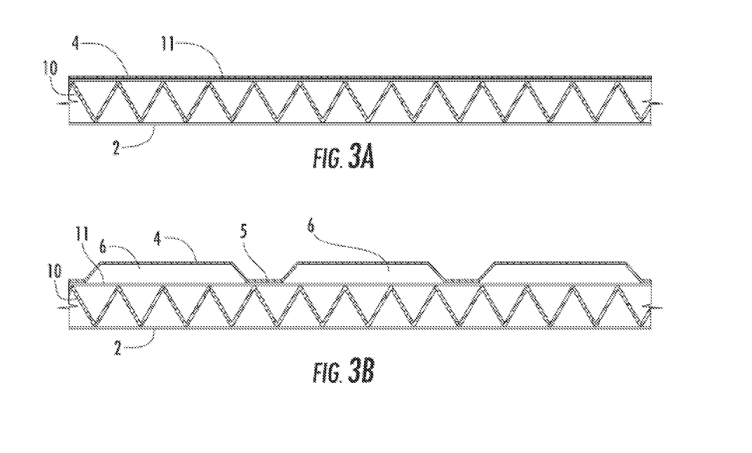

FIGS. 3a and 3b show cross sections of the containers depicted in FIGS. 1 and 2 respectively. FIG. 3a shows a section of the box where the aluminum foil 4 is attached to the inner surface of the cardboard 11, not viewable in the other drawings. The aluminum foil is applied in a tight manner with glue or other mastic. The inner portion of cardboard 10 can also be seen. In FIG. 3b one can see the cross section where air pockets are formed between the inner cardboard surface 11 and the aluminum foil 4. The glue line 5 separates and defines each of the pockets 6 from each other.

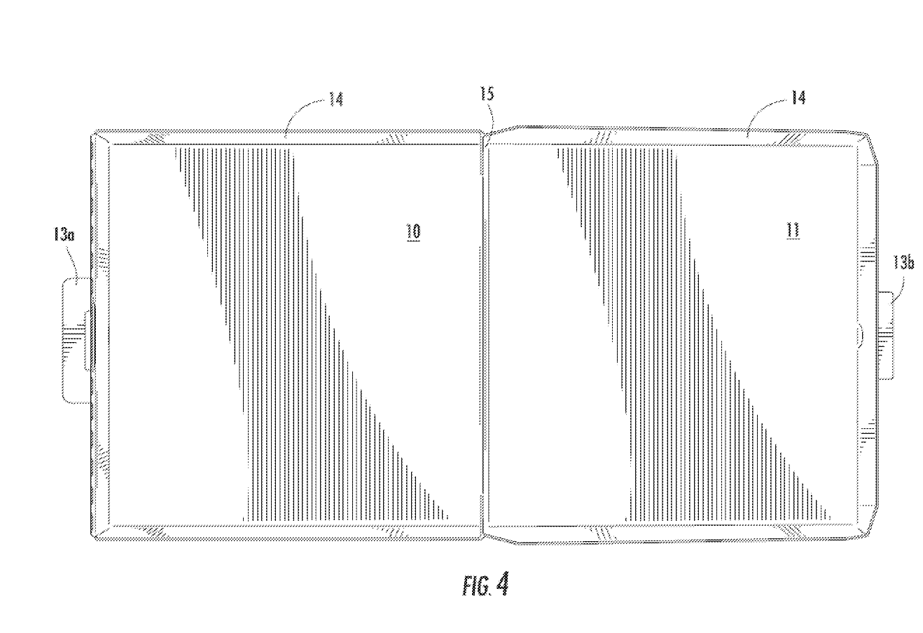

FIG. 4 shows an open sandwich container of the present invention viewed from the top looking at the inside. The bottom 10 and top11 inside of the container is coated with foil 14. The container folds closed at fold 15 and locks closed with tab 13b and slot 13a.

What is claimed is:

1. A food container having at least a portion of the interior, exterior or both surfaces of the container affixed with a layer of a heat reflective material.

2. A food container according to claim 1 wherein the heat reflective material is aluminum foil.

3. A food container according to claim 1 wherein the aluminum foil is affixed to the interior surface of the container.

4. A food container according to claim 1 wherein the aluminum foil covers the entire interior surface of the container.

5. A food container according to claim 2 wherein the heat reflective material is affixed to the inside surface of the food container in a manner that creates a plurality of air pockets between the reflective material and the interior surface.

6. A food container according to claim 1 which further comprises a loose piece of absorbent material for absorbing moisture from hot food placed in the container.

7. A food container according to claim 1 wherein the reflective material is only attached to the interior surface of the container that forms the upper surface when the container is closed.

8. A food container according to claim 1 wherein the container is made of cardboard or plastic.

9. A food container according to claim 1 wherein the reflective material is affixed to the outside surface of the container.

10. A food container according to claim 1 wherein the reflective material has openings for the passage of water vapor.

11. A food container according to claim 1 wherein there is a layer of plastic in between the food and the container.
